(19) United States
(12) Patent Application Publication
(10) Pub. No.: US 2010/0261609 A1
(43) Pub. Date: Oct. 14, 2010

(54) Phenoxy Alkanoate Herbicidal Composition and Method of Preparation and Use

(75) Inventors: Aristos Panayi, Taylors Hill (AU); Graeme Sutton, Ashwood (AU); Andrew John Wells, Hampton (AU)

Correspondence Address: PARFOMAK, ANDREW N.;NORRIS MCLAUGHLIN & MARCUS PA, 875 THIRD AVE, 8TH FLOOR, NEW YORK, NY, 10022, US

(73) Assignee: Nufarm Australia Limited, an Australian Company, Laverton North, Victoria (AU)

(21) Appl. No.: 12/305,710

(22) PCT Filed: Jun. 21, 2007
(86) PCT No.: PCT/AU2007/000860

§ 371 Date: May 13, 2010

Related U.S. Application Data
(60) Provisional application No. 60/815,866, filed on Jun. 23, 2006.

(51) Int. Cl. A01N 39/02; A01P 13/00

(52) U.S. Cl. 504/323

(57) ABSTRACT

This invention relates to a phenoxy alkanoate herbicide composition containing a phenoxyalkanoate amine salt and wherein the amine is a substituted amine and the total amount of substituted amine is at least a 20% molar excess based on the number of moles of phenoxyalkanoate.

This applications claims priority from U.S. Provisional Application No. 60/815,866 of 23 Jun. 2006 the contents of which are herein incorporated by reference.

### FIELD

This invention relates to herbicidal compositions, methods of preparing herbicidal compositions and a method of controlling weeds using the compositions.

### BACKGROUND

Phenoxy acid herbicides have been widely used as herbicides and include phenoxy-acetic, propionic and butyric acid herbicides and their esters. Phenoxy acetic acid herbicides including 2,4-Dichlorophenoxy acetic acid (2,4-D) and 4-chloro-2-methylphenoxy acetic acid (MCPA) and their esters such as the ethyl, 2-ethylbutyl and butoxy ethanol esters are used to control broadleaf weeds in crops such as cereals, sugar cane turf pastures and the like. Phenoxy acid herbicides are generally of formula

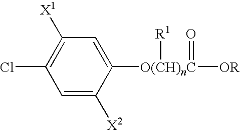

wherein
   R is the alcohol portion of the ester or is a salt counter ion such a substituted ammonium counter ion;
   X¹ is selected from hydrogen, halogen (preferably chloro) and methyl, preferably from hydrogen and chloro and most preferably is hydrogen;
   X² is selected from the group of hydrogen, halogen (preferably chloro) and methyl, preferably chloro and methyl and most preferably chloro;
   R¹ is selected from hydrogen and methyl and preferably is hydrogen; and
   n is from 1 to 3.

Phenoxy alkanoate herbicides may be used in the field in admixture with herbicides such as glyphosate to provide a fast knockdown and/or effective eradication of a broad range of weeds.

Recent glyphosate products have been introduced based on the potassium salt of glyphosate. The potassium salt of glyphosate has the advantage over other glyphosate forms of allowing higher loadings to be formulated than other salts thereby making it easier to handle and store.

We have found however that the existing phenoxy alkanoate herbicidal salts cannot be readily coformulated or tank mixed with other herbicides such as potassium glyphosate compositions, particularly where the compositions contain a high loading of herbicides and/or the mixing water is of poor quality.

This limits the usefulness of phenoxyalkanoate herbicides and other herbicides such as potassium glyphosate compositions in the field and has the potential to lead to ineffective use and/or wastage of herbicides in the field.

The discussion of documents, acts, materials, devices, articles and the like is included in this specification solely for the purpose of providing a context for the present invention. It is not suggested or represented that any or all of these matters formed part of the prior art base or were common general knowledge in the field relevant to the present invention as it existed before the priority date of each claim of this application.

### SUMMARY

We have found that phenoxy alkanoate herbicides in the presence of a significant excess of the amine which forms the counter ion show excellent compatibility with other herbicides and particularly potassium glyphosate allowing coformulation with other herbicides and particularly potassium glyphosate and tank mixing with other herbicides and particularly potassium glyphosate.

The invention provides a phenoxy alkanoate herbicide composition comprising a phenoxyalkanoate amine salt and wherein the amine is a substituted amine and the total amount of substituted amine is at least a 20% molar excess based on the number of moles of phenoxyalkanoate. Preferably the molar excess of substituted amine is at least 30% and more preferably at least 40%. The phenoxy alkanoate salt may be in the form of a solid, paste, liquid solution or mixture of these forms. In aqueous solution it is typically in the form of a dissociated salt and a range of counter ions may be present.

In one aspect of the invention the composition is an aqueous composition of a phenoxy alkanoate salt and has a pH of at least 8.5 and preferably at least 9, more preferably from 9 to 12, still more preferably from 9 to 11 and most preferably from 9 to 10.

Preferably the phenoxy alkanoate herbicide composition contains a compound of formula I

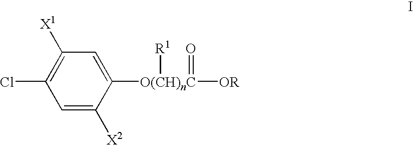

wherein
   X¹ is selected from hydrogen, halogen (preferably chloro) and methyl, preferably from hydrogen and chloro and most preferably is hydrogen;
   X² is selected from the group of hydrogen, halogen (preferably chloro) and methyl, preferably chloro and methyl and most preferably chloro;
   R¹ is selected from hydrogen and methyl and preferably is hydrogen;
   n is from 1 to 3; and
   R is a salt counter ion selected from the group consisting of substituted amine counter ions (preferably selected from dialkylamines, monoalkanolamines, dialkanolamines and trialkanolamines) wherein the total substituted amine molar content (preferably total dialkylamine mono- di- and tri alkanolamine content) is at least twenty percent in excess of the molar content of phenoxyalkanoate ion.

The preferred compositions of the invention contain at least 30% molar excess of the amine which forms a phenoxyalkanoate counter ion and preferably at least 40% molar excess.

The composition of the invention may be in the form of a concentrate containing the phenoxy alkanoate herbicide optionally in combination with other herbicides alternatively the composition may be in the form of a ready to use composition or tank mix composition comprising a dilute mixture of the phenoxyalkanoate optionally in combination with other herbicides and in particular potassium glyphosate.

The composition of the invention allows phenoxy alkanoate herbicides to be prepared and used at high concentration to prepare tank mixes of the phenoxy alkanoate with other herbicides particularly potassium glyphosate. The composition of the invention is preferably in the form of an aqueous concentrate containing at least 300 g, preferably at least 450 g and still more preferably at least 600 g (acid equivalent) per litre of aqueous concentrate. Even more preferably the composition of the invention comprises at least 620 g per litre and most preferably at least 650 g per litre (acid equivalent) of phenoxyalkanoate herbicide component which may consist of one or more phenoxyalkanoates in the form of amine salts-.

In a further aspect the invention provides a method of forming a tank mix composition of potassium glyphosate and a phenoxyalkanoate herbicide.

Throughout the description and the claims of this specification the word “comprise” and variations of the word, such as “comprising” and “comprises” is not intended to exclude other additives, components, integers or steps.

### DETAILED DESCRIPTION

The preferred compounds of formula I are amine salts of phenoxy alkanoic acids selected from the group consisting of:
2,4-D (2,4-dichlorophenoxyacetic acid),
2,4-DB 2-(2,4-dichlorophenoxy)butyric acid,
dichlorprop (RS)-2-(2,4-dichlorophenoxy)propionic acid,
dichlorprop-P (R)-2-(2,4-dichlorophenoxy)propionic acid,
fenoprop (±)-2-(2,4,5 trichlorophenoxy)propionic acid,
MCPA 4-chloro-o-tolyloxyacetic acid,
MCPB 4-(4-chloro-0-tolyloxy)butyric acid,
Mecoprop (RS)-2-(4-chloro-o-tolyloxy)propionic acid and
Mecoprop-P (R)-2-(4-chloro-o-tolyloxy)butyric acid.

The more preferred herbicides are 2,4-D, MCPA, dichlorprop, dichlorprop-P, mecoprop, mecoprop-P, 2,4-DB and MCPB.

The preferred amine counter ions are formed from amines of formula II

NR²R³R⁴ II

wherein at least one of R², R³ and R⁴ is independently selected from C₁ to C₆ alkyl and C₂ to C₆ alkanol and the others are independently selected from hydrogen, C₁ to C₆ alkyl and C₂ to C₆ alkanol. Preferably at least one of R², R³ and R⁴ is independently selected from C₁ to C₄ alkyl and C₂ to C₄alkanolamine and the others are independently selected from hydrogen, C₁ to C₄ alkyl and C₂ to C₄ alkanolamine.

Specific examples of amines include dimethylamine, diethylamine, ethanolamine, diethanolamine, triethanolamine, ethyl ethanolamine and isopropanolamine. In the more preferred embodiment of the invention the composition comprises at least a 20% molar excess, more preferably at least a 30% molar excess and most preferably at least a 40% molar excess (based on phenoxy alkanoate) of amines in the group consisting of include ethanolamine, diethanolamine, triethanolamine, ethyl ethanolamine and isopropanolamine. The composition of the invention preferably includes at least two substituted amines including a substituted amine selected from di C₂ to C₄ alkanolamines and at least one substituted amine selected from di C₁ to C₄ alkylamines.

18. The composition of the invention may and preferably will include casein which we have found to improve compatibility of the phenoxyalkanoate amine salts and other herbicides (particularly potassium glyphosate. The amount of casein may be at least a compatibility enhancing amount. In a preferred embodiment the composition according to the invention further comprising casein in an amount of from 0.05 to 10 parts by weight casein per 100 parts by weight phenoxyalkanoate acid equivalent. The amount of casein is preferably from 0.01 to 15% by weight of a concentrate composition and more preferable is from 0.1 to 10% by weight of the composition.

One significant advantage of the compositions of the invention is the compatibility with potassium glyphosate.

In one embodiment the invention provides a composition comprising

A. a phenoxy alkanoate herbicide composition containing a compound of formula I

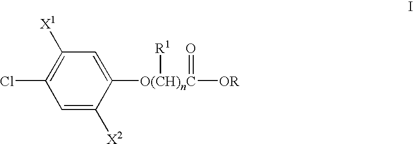

wherein
   X¹ is selected from hydrogen, halogen (preferably chloro) and methyl, preferably from hydrogen and chloro and most preferably is hydrogen;
   X² is selected from the group of hydrogen, halogen (preferably chloro) and methyl, preferably chloro and methyl and most preferably chloro;
   R¹ is selected from hydrogen and methyl and preferably is hydrogen; and
   n is from 1 to 3;
   R is a salt counter ion selected from the group consisting of substituted amine counter ions (preferably selected from monoalkanolamines, dialkanolamines and trialkanolamines) wherein the total substituted amine molar content (preferably total mono- di- and tri alkanolamine content) is at least twenty percent in excess (preferably at least 30% molar excess of the amine counter ion and more preferably at least 40% molar excess) based on phenoxyalkanoate; and
      B. potassium glyphosate.

Preferably the weight ratio of phenoxyalkanoate acid equivalent to potassium glyphosate as acid equivalent is in the range of from 1:100 to 5:1 and preferably from 1:80 to 5:1 and most preferably from 1:20 to 3:1.

Examples of herbicidal compositions according to the present invention (in which amounts are expressed on a weight basis) are as follows:
(i) aqueous concentrates which comprise from 5 to 90% by weight of a composition of compounds of formula I and amine, and from 2 to 15% of surfactant;
(ii) water soluble or wettable powders which comprise from 5 to 99.9% of a composition of compounds of formula I and amine, preferably from 0.1 to 20% e.g. 5 to 15% surfactant and optionally up to 88% (such as from 5 to 88% of solid diluent or carrier;
(iii) water dispersible or soluble granules which comprise from 1 to 99.9%, e.g. 25 to 95% of compounds of formula I, and preferably also from 0.1 to 15%, e.g. 2 to 10%, of surfactant and from 0 to 95% e.g. 5 to 95%, more preferably 20 to 60%, of solid diluent, e.g. clay, or water soluble solids or dispersant granulated with the addition of water to form a paste and then dried;

The most preferred compositions of the invention are aqueous concentrates containing from 5 to 30% phenoxy alkanoate and from 5 to 25% surfactant.

Aqueous concentrates of the invention preferably have a pH of at least 9.0 and preferably in the range of from 9.0 to 12.0 more preferably 9.0 to 11.0 and most preferably from 9.0 to 10.0.

The composition may be in the form of a dilute composition of the type which may, for example, be formed in a spray tank prior to spray application. Such composition may for example be in the form of an aqueous mixture containing in the range of from 0.1 to 5% by weight phenoxy alkanoate herbicide.

The invention further provides a method of forming a tank mix of phenoxy alkanoate herbicide and potassium glyphosate the method comprising;
providing a concentrate of phenoxyalkanoate herbicide the concentrate composition comprising at least one compound of formula I

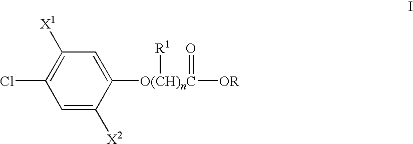

wherein
   X¹ is selected from hydrogen, halogen (preferably chloro) and methyl, preferably from hydrogen and chloro and most preferably is hydrogen;
   X² is selected from the group of hydrogen, halogen (preferably chloro) and methyl, preferably chloro and methyl and most preferably chloro;
   R¹ is selected from hydrogen and methyl and preferably is hydrogen; and
   n is from 1 to 3;
   R is a salt counter ion selected from the group consisting of substituted amine counter ions (preferably selected from monoalkanolamines, dialkanolamines and trialkanolamines) wherein the total substituted amine molar content (preferably total mono- di- and tri alkanolamine content) is at least twenty percent in excess (preferably at least 30% molar excess of the amine counter ion and more preferably at least 40% molar excess) of the molar content of phenoxyalkanoate ion said concentrate comprising at least 5% by weight phenoxy alkanoate component;
providing a potassium glyphosate concentrate (preferably an aqueous concentrate) comprising at least 30% by weight potassium glyphosate; combining the concentrates preferably in the presence of diluting water and making the composition up to the desired volume with water.

The composition is preferably applied spray application to the weeds to be controlled.

Examples of other surfactants include, nonaromatic-based surfactants, e.g. those based on heterocycles, olefins, aliphatics or cycloaliphatics, for example surface-active mono- or poly-alkyl-substituted and subsequently derivatized, e.g. alkoxylated, sulfated, sulfonated or phosphated, pyridine, pyrimidine, triazine, pyrole, pyrrolidine, furan, thiophene, benzoxazole, benzthiazole and triazole compounds, and/or aromatic-based surfactants, e.g. mono- or poly-alkyl-substituted and subsequently derivatized, e.g. alkoxylated, sulfated, sulfonated or phosphated, benzenes or phenols. The surfactants are generally soluble in the solvent phase and are preferably suitable for emulsifying it (together with active ingredients dissolved therein) upon dilution with water to give a spray liquor. The surfactant component when present in compositions according to the invention can, for example, comprise nonaromatic or aromatic surfactants or mixtures of nonaromatic and aromatic surfactants.

Examples of surfactants are listed below, in which EO=ethylene oxide units, such as PO=propylene oxide units and BO=butylene oxide units:

1) C₁₀-C₂₄-alcohols which may be alkoxylated, e.g. with 1-60 alkylene oxide units, preferably 1-60 EO and/or 1-30 PO and/or 1-15 BO in any order. The terminal hydroxyl groups of these compounds can be terminally capped by an alkyl, cycloalkyl or acyl radical having 1-24 carbon atoms. Examples of such compounds are:
1) Genapol® C, L, O, T, UD, UDD, X products from Clariant, Plurafac® and Lutensol® A, AT, ON, TO products from BASF, Marlipal® 24 and 013 products from Condea, Dehypon® products from Henkel, Ethylan® products from Akzo Nobel, such as Ethylan CD 120.
2) Anionic derivatives of the products described under b1) in the form of ether carboxylates, sulfonates, sulfates and phosphates and their inorganic salts (e.g. alkali metal and alkaline earth metal) and organic salts (e.g. those based on amine or alkanolamine), such as Genapol® LRO, Sandopane products, hostaphate, Hordaphos® products from Clariant.

Copolymers consisting of EO, PO and/or BO units, such as, for example, block copolymers, such as the Pluronic® products from BASF and the Synperonic® products from Uniquema with a molecular weight of from 400 to 10⁸.

Alkyleneoxy adducts of C₁-C₉ alcohols, such as Atlox 5000 from Uniquema or Hoe®-S3510 from Clariant.

3) Fatty acid and triglyceride alkoxylates, such as the Serdox NOG products from Condea or alkoxylated plant oils, such as soybean oil, rapeseed oil, corn oil, sunflower oil, cottonseed oil, linseed oil, coconut oil, palm oil, thistle oil, walnut oil, peanut oil, olive oil or rhicinus oil (i.e. castor oil), in particular rapeseed oil and castor oil, plant oils also being understood as meaning their transesterification products, e.g. alkyl esters, such as rapeseed oil methyl ester or rapeseed oil ethyl ester, for example the Emulsogen® products from Clariant, salts of aliphatic, cycloaliphatic and olefinic carboxylic acids and polycarboxylic acids, and alpha-sulfo fatty acid esters as available from Henkel. Particularly preferred in this group are castor oil ethoxylates such as Termul®1284 and Termul®1285 from Huntsman.
4) Fatty acid amide alkoxylates, such as the Comperlan products from Henkel or the Amam® products from Rhodia.

Alkyleneoxy adducts of alkynediols, such as the Surfynol products from Air Products. Sugar derivatives, such as amino and amido sugars from Clariant, glucitols from Clariant, alkyl polyglycosides in the form of the APG® products from Henkel or such as sorbitan esters in the form of the Span® or Tween® products from Uniquema or cyclodextrine esters or ethers from Wacker.

5) Surface-active cellulose and algine, pectin and guar derivatives, such as the Tylose® products from Clariant, the Manutex® products from Kelco and guar derivatives from Cesalpina.

Alkyleneoxy adducts based on polyol, such as Polyglycol products from Clariant. Interface-active polyglycerides and derivatives thereof from Clariant.

6) Sulfosuccinates, alkanesulfonates, paraffin- and olefin sulfonates, such as Netzer IS®, Hoe® S1728, Hostapur® OS, Hostapur® SAS from Clariant, Triton® GR7ME and GR5 from Union Carbide, Empimin® products from Albright and Wilson, Marion® PS65 from Condea.
7) Sulfosuccinamates, such as the Aerosol products from Cytec or the Empimin® products from Albright and Wilson.
8) Alkylene oxide adducts of fatty amines, quaternary ammonium compounds having 8 to 22 carbon atoms (C₈-C₂₂), such as, for example, the Genamin® C, L, O, T products from Clariant.
9) Surface-active zwitterionic compounds, such as taurides, betaines and sulfobetaines in the form of Tegotain® products from Goldschmidt, Hostapon® and Arkopon® products from Clariant.
10) Surface-active compounds based on silicone and/or silane, such as the Tegopren® products from Goldschmidt and the SE® products from Wacker, and the Bevaloid®, Rhodorsil® and Silcolapse® products from Rhodia (Dow Corning, Reliance, GE, Bayer).
11) Per- or polyfluorinated surface-active compounds, such as Fluowet® products from Clariant, the Bayowet® products from Bayer, the Zonyl® products from DuPont and products of this type from Daikin and Asahi Glass.
12) Interface-active sulfonamides, e.g. from Bayer.
13) Interface-active polyacrylic and polymethacrylic derivatives, such as the Sokalan® products from BASF.
14) Surface-active polyamides, such as modified gelatin or derivatized polyaspartic acid from Bayer and derivatives thereof.
15) Surface-active polyvinyl compounds, such as modified polyvinylpyrolidone, such as the Luviskol® products from BASF and the Agrimer® products from ISP or the derivatized polyvinylacetates, such as the Mowilith® products from Clariant or the butyrates, such as the Lutonal® products from BASF, the Vinnapas® and the Pioloform® products from Wacker or modified polyvinyl alcohols, such as the Mowiol® products from Clariant.
16) Surface-active polymers based on maleic anhydride and/or reaction products of maleic anhydride, and maleic anhydride and/or reaction products of copolymers which include maleic anhydride, such as the Agrimer®-VEMA products from ISP.
17) Surface-active derivatives of montane, polyethylene and polypropylene waxes, such as the Hoechst® waxes or the Licowet® products from Clariant.
18) Surface-active phosphonates and phosphinates, such as Fluowet®-PL from Clariant.
19) Poly- or perhalogenated surfactants, such as, for example Emulsogen®-1557 from Clariant.
20) Phenols which may be alkoxylated, for example phenyl (C₁-C₄)alkyl ethers or (poly)alkoxylated phenols [=phenol (poly)alkylene glycol ethers], for example having 1 to 50 alkyleneoxy units in the (poly)alkyleneoxy moiety, where the alkylene moiety preferably in each case has 1 to 4 carbon atoms, preferably phenol reacted with 3 to 10 mol of alkylene oxide, (poly)alkylphenols or (poly)alkylphenol alkoxylates [=polyalkylphenol (poly)alkylene glycol ethers], for example with 1 to 12 carbon atoms per alkyl radical and 1 to 150 alkyleneoxy units in the polyalkyleneoxy moiety, preferably tri-n-butylphenol or triisobutylphenol reacted with 1 to 50 mol of ethylene oxide, polyarylphenols or polyarylphenol alkoxylates [=polyarylphenol (poly)alkylene glycol ethers], for example tristyrylphenol polyalkylene glycol ethers with 1 to 150 alkyleneoxy units in the polyalkyleneoxy moiety, preferably tristyrylphenol reacted with 1 to 50 mol of ethylene oxide.
21) Compounds which formally represent the reaction products of the molecules described under 20) with sulfuric acid or phosphoric acid, and salts thereof neutralized with suitable bases, for example the acidic phosphoric esters of triethoxylated phenol, the acidic phosphoric ester of a nonylphenol reacted with 9 mol of ethylene oxide and the phosphoric ester of the reaction product of 20 mol of ethylene oxide and 1 mol of tristyrylphenol which has been neutralized with triethanolamine.
22) Benzenesulfonates, such as alkyl- or arylbenzenesulfonates, e.g. (poly)alkyl- and (poly)arylbenzenesulfonates which are acidic and neutralized with suitable bases, for example having 1 to 12 carbon atoms per alkyl radical or having up to 3 styrene units in the polyaryl radical, preferably (linear) dodecylbenzenesulfonic acid and oil-soluble salts thereof, such as, for example, the calcium salt or the isopropylammonium salt of dodecylbenzenesulfonic acid.

The invention will now be described with reference to the following examples. It is to be understood that the examples are provided by way of illustration of the invention and that they are in no way limiting to the scope of the invention.

### EXAMPLES

The following composition examples were prepared by mixing the components in the amounts specified.

### Example 1

A composition of the invention was prepared by mixing the following components in the amounts specified.

| Material | Amounts (kg) |
|---|---|
| 2,4-D acid technical (98%) | 0.6633 |
| Casein | 0.004 |
| Diethanolamine (85%) | 0.3381 (55% excess included) |
| Dimethylamine (60%) | 0.1278 |
| Water | to 1 Litre |

### Example 2

A composition of the invention was prepared by mixing the following components in the amounts specified.

| Material | Amounts (kg) |
|---|---|
| 2,4-D acid technical (98%) | 0.6888 |
| Casein | 0.004 |
| Diethanolamine (85%) | 0.3512 (55% excess included) |
| Dimethylamine (60%) | 0.1329 |
| Water | to 1 Litre |

### Example 3

A composition of the invention was prepared by mixing the following components in the amounts specified.

| Material | Amounts (kg) |
|---|---|
| 2,4-D acid technical (98%) | 0.6122 |
| Casein | 0.004 |
| Diethanolamine (85%) | 0.3123 (55% excess included) |
| Dimethylamine (60%) | 0.1181 |
| Water | to 1 Litre |
| Base molar ratio | |
| Diethanolamine:Dimethylamine | (42:58) |

The alkyleneoxy units are ethyleneoxy, propyleneoxy and butyleneoxy units, particularly preferably ethyleneoxy units.

### Example 4 and Example 5

The compositions of Example 4 and 5 were prepared by mixing the following components in the amounts by weight shown:

| Example No | Component | Weight (grams) |
|---|---|---|
| 4 | 2,4-D acid | 300 |
| | Monoisopropylamine | 87 |
| | H₃PO₄ | 30 |
| | Casein | 10 |
| | NMP | 50 |
| | water | to 1 Litre |
| 5 | 2,4-D (98%) | 485 |
| | Diethanolamine 85% | 247 |
| | Dimethylamine 60% | 94 |
| | Casein | 4 |
| | water | to 1 Litre |

### Example 6

This example examines the compatibility of compositions of the invention with a commercially available potassium glyphosate composition containing 540 g/L (acid equivalent of potassium glyphosate) sold under the registered trademark ROUNDUP POWERMAX.

| Parameter | Example 1 | Exampe 2 | Example 3 | Example 4 | Example 5 | CE1 | CE2 |
|---|---|---|---|---|---|---|---|
| Assay 2,4-D g/L | 650 | 675 | 600 | 300 | 475 | 625 | |
| SG at 20° C. | 1.260 | 1.272 | 1.245 | 1.117 | 1.207 | | |
| pH range (neat) | 9.0-9.5 | 9.0-9.5 | 9.0-9.5 | 8.5-9.5 | 9.0-9.5 | | |
| % Crystallisation at 0° C. | 35% but re- | 30% but re- | 0 | 0 | 0 | | |
| after seeding | dissolves on | dissolves on | | | | | |
| | rewarming to | rewarming to | | | | | |
| | ambient | ambient | | | | | |
| Precipitation (mL) after 2 h of | 0 in Melbourne | 0 in Melbourne | 0 in Melbourne | 0 in Melbourne | 0 in Melbourne | Heavy | Heavy |
| mixture of 5 mL ROUNDUP | tap and CIPAC | tap and CIPAC | tap and CIPAC | tap and CIPAC | tap and CIPAC | Precipitate | Precipitate |
| POWERMAX and enough | Standard C | Standard C | Standard C | Standard C | Standard C | | |
| formulation to give 1.5 g | | | | | | | |
| 2,4-D in water to 100 mL | | | | | | | |
| Precipitation (mL) after 2 h of | 0 | 0 | 0 | 0 | 0 | Heavy | Heavy |
| 5 mL formulation in 95 ml | | | | | | Precipitate | Precipitate |
| standard C water | | | | | | | |

CE1, a commercially available 2,4-D product having a loading of 625 g (acid equivalent) in the form of the diethanolamine and dimethylamine salts per litre with less than 20% excess of substituted amine.
CE2 was a commercially available 2,4-D product an aqueous solution containing 300 g (acid equivalent) per litre as the monoisoproylamine salt.

### Example 7

This example examines the efficacy of compositions of the invention when compared with potassium glyphosate alone and mixtures of phenoxy acid ester herbicides with potassium glyphosate. A small plot replicated field trial was established in a paddock of Faba beans (Vicia faba) in Victoria's Wimmera district. The objective of the trial was to test compositions of the invention including potassium glyphosate and compare them with potassium glyphosate lone and mixtures of potassium glyphosate with esters of phenoxy acids.

Weeds present in the Faba bean crop were Barley (Hordeum vulgare), Annual ryegrass (Lolium rigidum), and Vetch (Vicia sativa).

Treatments were applied in August with a hand held boom using Airmix 110 01 nozzles producing a coarse droplet and a water rate of 60 L/ha.

It is likely that dry conditions during the trial caused stress in the plants, particularly the Faba beans, leading to poor control from some treatments.

Roundup PowerMAX used alone displayed a lower control of Faba beans compared to other treatments which contained a phenoxy salt herbicide in the mix.

There were no significant differences between any treatments in the final level of grass control. All treatments gave complete control of the Barley and Ryegrass. This indicates that there was no antagonism between the Roundup PowerMAX and any of the phenoxy products used in the trial.

### Treatment Details

### Product Details

Details of products used in the trial.

| Product | Active constituent |
|---|---|
| Roundup PowerMAX | 540 g glyphosate as K/L aqueous solution |
| | concentrate |
| LV Estercide 600 | 600 g 2,4-D as 2-ethylhexylester/L emulsifiable |
| | concentrate |
| Example 5 | 475 g 2,4-D as dma/dea/L aqueous solution |
| | concentrate |

### Spray Details

### Treatment Type: Handboom

### Nozzle Type Agrotop Airmix 110 01

### Nozzle Spacing: 50 cm

### No of Nozzles: 5

### Spray Volume: 60 L/ha

### Water Pressure: 2.5 bar

Water Source Horsham mains water

### Water pH: 7.3

Water Salt: 180 us/cm EC

### Water Total Hardness: 42 (CaCO₃)

### Propellant: LPG

### Target Details

Weed condition and density

| | | DENSITY | |
|---|---|---|---|
| WEED | GROWTH STAGE | Plants/m² | WEED SIZE |
| Faba Bean (Vicia | Early flowering | 15 | 30 cm high |
| faba) | | | |
| Barley (Hordeum | Late stem | 30 | 15-25 cm high |
| vulgare) | elongation | | |
| Annual ryegrass | Fully tillered | 53 | 10-15 cm high |
| (Lolium rididum) | | | |
| Vetch (Vicia sativa) | 3-6 branches | 6 | 10 cm diameter |

### Conditions at Application

### Time of Year: August

### Application Time: 11.00 am

### Temperature ° C.: 11.5

### Rel Humidity %: 55

Wind km/h: 4.5
Wind direction: S

### Frosts: Three Days Prior

Rain Before: 12 mm 2 days prior to application
Rain After: 3 mm 8 days after application

### Soil Moisture Marginal

### Dew: Nil

Plots all sprayed in a North to South direction

### Treatments

Treatments used in trial

| Example | Product | Rate (L/ha) |
|---|---|---|
| CE3 | Roundup PowerMax | 0.8 |
| CE4 | Roundup PowerMax | 0.8 |
| | LV Estercide 600 | 0.25 |
| CE5 | Roundup PowerMax | 0.8 |
| | LV Estercide 600 | 0.5 |
| CE6 | Roundup PowerMax | 0.8 |
| | LV Estercide 600 | 0.9 |
| Example 6 | Roundup PowerMax | 0.8 |
| | Example 5 | 0.32 |
| Example 7 | Roundup PowerMax | 0.8 |
| | Example 5 | 0.63 |
| Example 8 | Roundup PowerMax | 0.8 |
| | Example 5 | 1.14 |
| Control | Untreated | |

### Weed Control

Visual ratings (Percent control) were conducted on a whole plot basis as well as individual weed basis at 7, 13, and 31 days after application to assess weed control using a rating scale of 0-100 where:
0=No damage evident
10=Negligible: discolouration, distortion, and/or stunting barely seen.
20=Slight: discolouration, distortion, and/or stunting clearly seen.
30=Moderate damage: moderate discolouration, marked distortions and/or stunting, recovery expected.
40=Substantial damage: much discolouration, distortions and/or stunting, some damage probably irreversible.
50=Majority of plants damaged, many irreversibly, some necrosis, discolouration and distortions severe.
60=Nearly all plants damaged, most irreversibly, some plants killed (<40%), substantial necrosis and distortion.
70=Severe: Substantial number of plants killed (40-60%), much necrosis and distortion.
80=Very severe: Majority of plants killed (60-80%), remainder show much necrosis and wilting.
90=Remaining live plants (<20%) mostly discoloured and distorted permanently or desiccated.
100=Complete loss of plant.

### Data Analysis

An analysis of variance (ANOVA) was conducted on data using the ARM7 statistical analysis package. Treatment means were separated using Duncans New Multiple Range Test at the 95% level of probability. Treatments with letters in common are not significantly different.

Untreated was removed from analysis of percentage weed brownout and for final weed count analysis.

### Final Weed Counts

Final weed counts were conducted using a 0.25 m² quadrant with five random sub-samples taken for each plot. Results were than converted into surviving plants/m².

### Results

### Weed Control 6-DAA (Jan. 9, 2006)

Visual weed brownout 6-DAA

| | | | | Pest Name | | | | | | | | | |
|---|---|---|---|---|---|---|---|---|---|---|---|---|---|
| | | | | | | Spring | | Annual | | Common | | | |
| | | | | Faba bean | | barley | | Ryegrass | | vetch | | Overall | |
| | | | | Description | | | | | | | | | |
| | | | | Visual | | Visual | | Visual | | Visual | | Visual | |
| | | | | brownout % | | brownout % | | brownout % | | brownout % | | brownout % | |
| | Treatment | | Rate | Days After Application | | | | | | | | | |
| Example | Name | Rate | Unit | 6 | | 6 | | 6 | | 6 | | 6 | |
| CE3 | Roundup PowerMax | 0.8 | l/ha | 13 | c | 40 | b | 40 | a | 0 | c | 40 | b |
| CE4 | Roundup PowerMax | 0.8 | l/ha | 40 | b | 40 | b | 47 | a | 20 | b | 40 | b |
| | LV Estercide 600 | 0.25 | l/ha | | | | | | | | | | |
| CE5 | Roundup PowerMax | 0.8 | l/ha | 40 | b | 40 | b | 47 | a | 20 | b | 40 | b |
| | LV Estercide 600 | 0.5 | l/ha | | | | | | | | | | |
| CE6 | Roundup PowerMax | 0.8 | l/ha | 40 | b | 40 | b | 40 | a | 20 | b | 40 | b |
| | LV Estercide 600 | 0.9 | l/ha | | | | | | | | | | |
| Example 6 | Roundup PowerMax | 0.8 | l/ha | 40 | b | 40 | b | 40 | a | 20 | b | 40 | b |
| | Ex 5 | 0.32 | l/ha | | | | | | | | | | |
| Example 7 | Roundup PowerMax | 0.8 | l/ha | 40 | b | 43 | ab | 40 | a | 20 | b | 43 | ab |
| | Ex 5 | 0.63 | l/ha | | | | | | | | | | |
| Example 8 | Roundup PowerMax | 0.8 | l/ha | 40 | b | 40 | b | 43 | a | 20 | b | 40 | b |
| | Ex 5 | 1.14 | l/ha | | | | | | | | | | |
| Control | Untreated | | | 0 | | 0 | | 0 | | 0 | | 0 | |

| | | | | | |
|---|---|---|---|---|---|
| LSD (P = .05) | 2.4 | 4.4 | 6.1 | 2.4 | 4.4 |
| Standard Deviation | 1.4 | 2.7 | 3.7 | 1.4 | 2.7 |
| CV | 3.59 | 6.42 | 8.55 | 7.61 | 6.42 |

Means followed by same letter do not significantly differ (P = .05, Duncan's New MRT)
Mean comparisons performed only when AOV Treatment P(F) is significant at mean comparison OSL.
Untreated treatment(s) 17 excluded from analysis.

### Weed Control 16-DAA

Visual weed brownout 16-DAA

| | | | | Pest Name | | | | | | | | | |
|---|---|---|---|---|---|---|---|---|---|---|---|---|---|
| | | | | | | Volunteer | | Annual | | Common | | | |
| | | | | Faba bean | | barley | | ryegrass | | vetch | | Overall | |
| | | | | Description | | | | | | | | | |
| | | | | Visual | | Visual | | Visual | | Visual | | Visual | |
| | | | | brownout | | brownout % | | brownout % | | brownout % | | brownout % | |
| | Treatment | | Rate | Days After Application | | | | | | | | | |
| Example | Name | Rate | Unit | 16 | | 16 | | 16 | | 16 | | 16 | |
| CE3 | Roundup PowerMax | 0.8 | l/ha | 20 | f | 90 | a | 90 | a | 20 | e | 53 | d |
| CE4 | Roundup PowerMax | 0.8 | l/ha | 53 | de | 90 | a | 90 | a | 67 | cd | 77 | bc |
| | LV Estercide 600 | 0.25 | l/ha | | | | | | | | | | |
| CE5 | Roundup PowerMax | 0.8 | l/ha | 60 | cd | 90 | a | 90 | a | 77 | abc | 80 | bc |
| | LV Estercide 600 | 0.5 | l/ha | | | | | | | | | | |
| CE6 | Roundup PowerMax | 0.8 | l/ha | 63 | bc | 90 | a | 90 | a | 87 | a | 80 | bc |
| | LV Estercide 600 | 0.9 | l/ha | | | | | | | | | | |
| Example 6 | Roundup PowerMax | 0.8 | l/ha | 57 | cde | 90 | a | 90 | a | 73 | bcd | 77 | bc |
| | Ex 5 | 0.32 | l/ha | | | | | | | | | | |
| Example 7 | Roundup PowerMax | 0.8 | l/ha | 60 | cd | 90 | a | 90 | a | 77 | abc | 80 | bc |
| | Ex 5 | 0.63 | l/ha | | | | | | | | | | |
| Example 8 | Roundup PowerMax | 0.8 | l/ha | 63 | bc | 90 | a | 90 | a | 87 | a | 80 | bc |
| | Ex 5 | 1.14 | l/ha | | | | | | | | | | |
| Control | Untreated control | | | 0 | | 0 | | 0 | | 0 | | 0 | |

| | | | | | |
|---|---|---|---|---|---|
| LSD (P = .05) | 7.8 | 0.0 | 0.0 | 9.3 | 6.4 |
| Standard Deviation | 4.7 | 0.0 | 0.0 | 5.6 | 3.8 |
| CV | 7.86 | 0.0 | 0.0 | 7.72 | 4.88 |

Means followed by same letter do not significantly differ (P = .05, Duncan's New MRT)
Mean comparisons performed only when AOV Treatment P(F) is significant at mean comparison OSL.
Untreated treatment(s) 17 excluded from analysis.

### Weed Control 27-DAA

Final weed counts for all weeds and visual control of Faba beans 27-DAA

| | | | | Pest Name | | | | | | | | | |
|---|---|---|---|---|---|---|---|---|---|---|---|---|---|
| | | | | | | Spring | | Annual | | Common | | | |
| | | | | Faba bean | | barley | | ryegrass | | vetch | | Faba bean | |
| | | | | Rating Unit | | | | | | | | | |
| | | | | Plants/m2 | | Plants/m2 | | Plants/m2 | | Plants/m2 | | % | |
| | | | | Number of Subsamples | | | | | | | | | |
| | | | | 5 | | 5 | | 5 | | 5 | | | |
| Example | Treatment | | Rate | Days After Application | | | | | | | | | |
| No. | Name | Rate | Unit | 27 | | 27 | | 27 | | 27 | | 27 | |
| CE3 | Roundup PowerMax | 0.8 | l/ha | 10.4 | ab | 0.0 | b | 1.1 | b | 4.8 | a | 43 | d |
| CE4 | Roundup PowerMax | 0.8 | l/ha | 6.7 | bc | 0.0 | b | 0.0 | b | 1.3 | a | 63 | c |
| | LV Estercide 600 | 0.25 | l/ha | | | | | | | | | | |
| CE5 | Roundup PowerMax | 0.8 | l/ha | 9.1 | bc | 0.0 | b | 0.0 | b | 2.1 | a | 72 | ab |
| | LV Estercide 600 | 0.5 | l/ha | | | | | | | | | | |
| CE6 | Roundup PowerMax | 0.8 | l/ha | 7.7 | bc | 0.0 | b | 0.5 | b | 1.1 | a | 73 | ab |
| | LV Estercide 600 | 0.9 | l/ha | | | | | | | | | | |
| Example 6 | Roundup PowerMax | 0.8 | l/ha | 8.8 | bc | 0.0 | b | 0.5 | b | 0.3 | a | 68 | bc |
| | Ex 5 | 0.32 | l/ha | | | | | | | | | | |
| Example 7 | Roundup PowerMax | 0.8 | l/ha | 7.5 | bc | 0.0 | b | 0.0 | b | 2.4 | a | 70 | abc |
| | Ex 5 | 0.63 | l/ha | | | | | | | | | | |
| Example 8 | Roundup PowerMax | 0.8 | l/ha | 6.1 | bc | 0.0 | b | 0.0 | b | 0.3 | a | 77 | a |
| | Ex 5 | 1.14 | l/ha | | | | | | | | | | |
| Control | Untreated | | | 13.6 | a | 24.0 | a | 57.1 | a | 5.9 | a | 0.0 | |

| | | | | | |
|---|---|---|---|---|---|
| LSD (P = .05) | 3.72 | 6.68 | 15.29 | 6.00 | 6.11 |
| Standard Deviation | 2.23 | 4.01 | 9.17 | 3.60 | 3.67 |
| CV | 28.65 | 284.0 | 249.87 | 115.26 | 5.3 |

Means followed by same letter do not significantly differ (P = .05, Duncan's New MRT)
Mean comparisons performed only when AOV Treatment P(F) is significant at mean comparison OSL.
Untreated treatment(s) 17 excluded from analysis in final column (Faba bean visual % control)

The response observed for Examples 6, 7 and 8 was equivalent to the corresponding examples containing equivalent amounts of phenoxy acid as the ester and were superior to potassium glyphosate used alone.

Accordingly the compositions of the invention based on phenoxy acid salt herbicides show compatibility with potassium glyphosate and the activity of phenoxy acid esters. They have significant advantages of phenoxy acid salts in water solubility and convenience of handling but avoid the disadvantages of reduced activity and poor compatibility found with prior art phenoxy acid salts.

Finally, it is understood that various other modifications and/or alterations may be made without departing from the spirit of the present invention as outlined herein.

1. A phenoxy alkanoate herbicidal composition comprising a phenoxyalkanoate amine salt and wherein the amine is a substituted amine and the total amount of substituted amine is at least a 20% molar excess based on the number of moles of phenoxyalkanoate.

2. A phenoxy alkanoate herbicide composition according to claim 1 comprising at least one compound of formula I 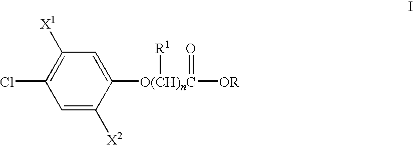
wherein
X¹ is selected from hydrogen, halogen (preferably chloro) and methyl, preferably from hydrogen and chloro and most preferably is hydrogen;
X² is selected from the group of hydrogen, halogen (preferably chloro) and methyl, preferably chloro and methyl and most preferably chloro;
R¹ is selected from hydrogen and methyl and preferably is hydrogen; n is from 1 to 3; and
R is a substituted amine counter ion.

3. A herbicidal composition according to claim 2 wherein the total substituted amine is at least thirty percent in excess of the molar content of phenoxyalkanoate.

4. A herbicidal composition according to claim 2 wherein the total substituted amine is at least fourty percent in excess of the molar content of phenoxyalkanoate.

5. A herbicidal composition according to claim 2 wherein R is a salt counter ion selected from alkyl amines, dialkylamines, trialkylamines, monoalkanolamines, dialkanolamines and trialkanolamines wherein the total alkylamines, dialkylamines, triakylamines, mono- di- and tri alkanolamine content is at least 20% in excess of the molar content of phenoxyalkanoate.

6. A herbicidal composition according to claim 5 comprising at least 30% molar excess of the amine based on the phenoxyalkanoate.

7. The herbicidal composition according to claim 1 in the form of an aqueous concentrate containing at least 5% by weight of the total composition of phenoxyalkanoate herbicide component which may consist of one or more phenoxyalkanoates in the form of amine salts.

8. A composition according to claim 1 wherein the phenoxy alkanoate is derived from at least one acid selected from the group consisting of:
2,4-D (2,4-dichlorophenoxyacetic acid),
2,4-DB 2-(2,4-dichlorophenoxy)butyric acid,
dichlorprop (RS)-2-(2,4-dichlorophenoxy)propionic acid,
dichlorprop-P (R)-2-(2,4-dichlorophenoxy)propionic acid,
fenoprop (±)-2-(2,4,5 trichlorophenoxy)propionic acid,
MCPA 4-chloro-o-tolyloxyacetic acid,
MCPB 4-(4-chloro-O-tolyloxy)butyric acid,
Mecoprop (RS)-2-(4-chloro-o-tolyloxy)propionic acid and
Mecoprop-P (R)-2-(4-chloro-o-tolyloxy)butyric acid.

9. A herbicidal composition according to claim 1 wherein the phenoxy alkanoate is derived from at least one acid selected from the group consisting of 2,4-D, MCPA, dichlorprop, dichlorprop-P, mecoprop, mecoprop-P, 2,4-DB and MCPB.

10. A herbicidal composition according to claim 2 wherein the amine counter ion is formed from amines of formula II
NR²R³R⁴ II
wherein at least one of R², R³ and R⁴ is independently selected from C₁ to C₆ alkyl and C₂ to C₆ alkanol and the others are independently selected from hydrogen, C₁ to C₆ alkyl and C₂ to C₆ alkanol.

11. A herbicidal composition according to claim 10 wherein at least one of R², R³ and R⁴ is independently selected from C₁ to C₄ alkyl and C₂ to C₄alkanolamine and the others are independently selected from hydrogen, C₁ to C₄ alkyl and C₂ to C₄ alkanolamine.

12. A herbicidal composition according to claim 2 wherein the counter ion is formed from at least one amine selected from the group consisting of ethanolamine, diethanolamine, triethanolamine, ethyl ethanolamine and isopropanolamine.

13. A herbicidal composition according to claim 1 in the form of an aqueous composition having a pH in the range of from 8.5 to 11.

14. A herbicidal composition according to claim 1 wherein the composition contains at least 300 g phenoxyalkanoate herbicide (acid equivalent) per litre of composition.

15. A composition according to claim 14 wherein the composition contains at least 450 g/L phenoxyalkanoate herbicide acid equivalent.

16. A herbicidal composition according to claim 2 wherein the composition comprises (in which amounts are expressed on a weight basis) as follows:
(i) aqueous concentrate which comprise from 5 to 90% of a composition of compounds of formula I and substituted amine, and from 2 to 15% of surfactant;
(ii) water soluble or wettable powders which comprise from 5 to 99.9% of a composition of compounds of formula I and amine from 0.1 to 20% surfactant and optionally up to 88% of solid diluent or carrier;
(iii) water dispersible or soluble granules which comprise from 1 to 99.9%, from 0.1 to 15 surfactant and from 0 to 95% solid diluent or dispersant.

17. A herbicidal composition comprising:
A. a phenoxy alkanoate herbicide composition containing a compound of formula I 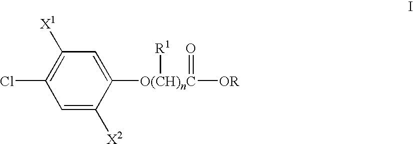
wherein
X¹ is selected from hydrogen, halogen (preferably chloro) and methyl, preferably from hydrogen and chloro and most preferably is hydrogen;
X² is selected from the group of hydrogen, halogen (preferably chloro) and methyl, preferably chloro and methyl and most preferably chloro;
R¹ is selected from hydrogen and methyl and preferably is hydrogen; and
n is from 1 to 3;
R is a salt counter ion selected from the group consisting of substituted amine counter ions (preferably selected from monoalkanolamines, dialkanolamines and trialkanolamines) wherein the total substituted amine molar content (preferably total mono- di- and tri alkanolamine content) is at least twenty percent in excess (preferably at least 30% molar excess of the amine counter ion and more preferably at least 40% molar excess) of the molar content of phenoxyalkanoate ion; and
B. potassium glyphosate;
wherein the weight ratio of phenoxyalkanoate (acid equivalent) to potassium glyphosate (acid equivalent) is in the range of from 1:100 to 5:1.

18. A herbicidal composition according to claim 1 in the form of an aqueous concentrate comprising from 5 to 30% by weight phenoxy alkanoate and from 5 to 25% by weight of a surfactant.

19. A herbicidal composition according to claim 1 in the form of a dilute composition for spray application containing 0.1 to 10 g phenoxy alkanoate herbicide (acid equivalent) per litre of spray liquor and a ratio of phenoxy alkonate:glyphosate in the range from 1:100 to 5:1.

20. A herbicidal composition according to claim 1 further comprising casein in an amount of from 0.05 to 10 parts by weight casein per 100 parts by weight phenoxyalkanoate acid equivalent.

21. (canceled)
